(19) United States
(12) Patent Application Publication
(10) Pub. No.: US 2005/0015300 A1
(43) Pub. Date: Jan. 20, 2005

(54) System and method for managing incentive offers

(76) Inventors: Mark Smith, West Hartford, CT (US); Tim Halfman, Schaumburg, IL (US); Brian Rock, Kildeer, IL (US)

Correspondence Address: BACHMAN & LAPOINTE, P.C., 900 CHAPEL STREET, SUITE 1201, NEW HAVEN, CT, 06510, US

(21) Appl. No.: 10/622,305

(22) Filed: Jul. 16, 2003

(51) Int. Cl. G06F 17/60

(52) U.S. Cl. 705/14

(57) ABSTRACT

A system and a method for handling the redemption, clearing and settlement of a large number of individually targeted offers is provided. The method broadly comprises the steps of compiling a database of electronic offers, allowing access to the database by at least one point of sale system, providing said at least one point of sale system with a redemption engine for validating at least one offer to be made to a consumer while a sales transaction is being processed by the at least one point of sale system, identifying a consumer and a sales transaction event involving the consumer, determining whether electronically stored conditions of any offer available to the consumer and stored on the database have been satisfied using the redemption engine, and providing a reward to the consumer at the at least one point of sale system if the electronically stored conditions of the offer have been satisfied.

### BACKGROUND OF THE INVENTION

The present invention relates to a system and a method for handling the redemption, clearing and settlement of a multiplicity of individually targeted offers originating from a variety of sources.

More than $100 billion is spent annually on promotions in the grocery industry. Grocery retailers possess and extensive reservoir of individual customer-identified data produced by their frequent shopper programs. Sophisticated data mining and related techniques are now available for efficiently and effectively analyzing such data. There are also a variety of media capable of delivering targeted offers to individual consumers on a mass scale. Competitive pressures are threatening retailers' customer base and reinforce the need to utilize effective customer retention/acquisition programs. Undifferentiated markdowns unnecessarily erode retailers' shrinking margins. There are increasing demands for accountability on the use of promotional funds and tie-ins to identifiable results.

Notwithstanding these pressures and the availability of scalable and affordable tools for targeting and delivering promotional offers at the individual item, household and consumer level, it is not possible to implement targeted promotions on a mass scale with the systems presently in use for clearing paper coupons and non-targeted electronic offers. As a practical matter, the off-line manual systems for clearing paper coupons cannot accommodate potentially millions of individualized targeted offers. Even more critically, such systems are incapable of managing the geometrically more complex needs for validation and security in the world of targeted offers. The limitations of current point of sale software do not include the capacity to electronically process large volumes of targeted offers.

There is a need for a system and method which is capable of handling the redemption, clearing, and settlement of a multiplicity of individual targeted offers, originating from a variety of sources.

### SUMMARY OF THE INVENTION

Accordingly, it is an object of the present invention to provide a system and a method for handling the redemption, clearing, and settlement of a large number of individually targeted offers.

The foregoing object is attained by the system and method of the present invention.

In accordance with the present invention, a method for handling the redemption, clearing and settlement of a large number of individually targeted offers is provided. The method broadly comprises the steps of compiling a database of electronic offers, allowing access to the database by at least one point of sale system, providing said at least one point of sale system with a redemption engine for validating at least one offer to be made to a consumer while a sales transaction is being processed by the at least one point of sale system, identifying a consumer and a sales transaction event involving the consumer, determining whether electronically stored conditions of any offer available to the consumer and stored on the database have been satisfied using the redemption engine, and providing a reward to the consumer at the at least one point of sale system if the electronically stored conditions of the offer have been satisfied.

Further, in accordance with the present invention, a method for processing targeted incentive offers broadly comprises the steps of electronically entering information about at least one targeted offer into a central database, placing the database into communication with a point-of-sale system at another location, transferring data about each redeemed offer from the point of sale system for validation, validating each said redeemed offer, electronically determining from the data an amount of money to be received by a seller from at least one offer source, providing a report of monies to be received to the seller, and providing a statement of monies to be paid to the seller to each offer source.

Further, in accordance with the present invention, a system for handling the redemption, clearing and settlement of a large number of individually targeted offers is provided. The system comprises a database of electronic offers, means for allowing access to the database by at least one point of sale system, means for identifying a consumer and a sales transaction event, means for determining whether electronically stored conditions of any offer available to the consumer and stored on the database have been satisfied, and means for providing a reward to the consumer at the at least one-point of sale system if the electronically stored conditions of the offer-have been satisfied.

Still further, a system for processing targeted incentive offers is provided. The system comprises a central database having information about at least one targeted offer, means for placing the database in communication with a point-of-sale system at another location, means for transferring data about each redeemed targeted offer from the point-of-sale system for validation, means for validating each redeemed targeted offer, means for electronically determining from the data an amount of money to be received by a seller from at least one offer source, means for providing a report of monies to be received to the seller, and means for providing a statement of monies to be paid to the seller to each offer source.

Other details of the system and method for managing incentive offers of the present invention, as well as other objects and advantages attendant thereto, are set forth in the detailed description and the accompanying drawings, wherein like reference numerals depict like elements.

### BRIEF DESCRIPTION OF THE DRAWINGS

FIG. 1 is a schematic representation of a system for handling offers in accordance with the present invention;

FIG. 2 is a schematic representation of a central processing center used in the system of the present invention; and

FIG. 3 is a schematic representation of the connection between a paper coupon audit center and the central processing center of FIG. 2.

### DETAILED DESCRIPTION OF THE PREFERRED EMBODIMENT(S)

The present invention pertains to a system and a method for handling the redemption, clearing and settlement of a large number of individually targeted offers including electronic offers created for targeted individuals and paper coupons used by individuals as part of a sales transaction.

A promotional or incentive offer consists of offer properties, conditions, and rewards. These details apply to all stores or locations in which the targeted offer is to be made available, and to all customers or consumers who are eligible to receive the targeted offer. Offer properties are the data elements that serve to generally describe an offer including, but not limited to, a description, valid date range, and the number of times a customer may receive a reward associated with that offer. Other details which may be part of the offer properties include the offer sponsor, whether the offer is to be treated as a store or manufacturer discount for sales tax purposes, and other considerations.

Conditions are the rules or requirements for receiving the reward(s) associated with the targeted offer. The conditions associated with a targeted offer are determined by combining condition sets using “and” logic. A condition set defines a set of possible requirements that might be met by a customer, triggered at a point of sale by the purchases of the customer or the circumstances under which the transaction occurs.

There are five condition set types available: (1) item purchase condition which requires the purchase of a certain item or items; (2) department purchase condition which requires the purchase of items in a certain department or departments; (3) total purchase condition which requires total purchases of a certain amount; (4) time of day condition which defines a time period in which the reward(s) may be received; and (5) day of week condition which defines the days of the week on which the rewards may be received. Only one type may be allowed for each condition set but more than one condition set may contain the same type. Note that multiple “time of day” or “day of week” condition sets would not be logical.

Rewards are the benefits received by the customer when the conditions are met. The rewards associated with a targeted offer are determined by combining reward sets using “and” logic. A reward set defines a set of possible awards that might be given to a customer, provided they have made the issuance of that award possible. For example, a free item must be in the shopping basket in order to be awarded.

There are five reward set types available: (1) item discount reward which is applied to the price of a specific item or items; (2) department discount reward which is applied to the price of items in a certain department or departments; (3) total discount reward which is applied to the total price of a shopping basket; (4) free item reward which reduces to zero the price of a specific item or items; and (5) replacement price reward which introduces a new price for a specific item or items. Only one type is allowed for each reward set but more than one reward set may contain the same type. Note that all rewards are given when the conditions are met and it is possible to issue the reward. Also note that the price of an item will never be reduced below zero by the issuance of a reward. At least one condition set and at least one reward set are required for every targeted offer.

A customer offer is a customer specific variation of an offer. The customer offer contains replacement values for some of the offer properties and for the rewards. These replacement values are overlaid on top of the generic values when a target customer identifies himself/herself at a point of sale by means of an identification card containing a frequent shopper number. It should be noted that the value of the reward may be varied by customer, not the items that are eligible to receive it. This means that the free item reward set type is not meaningfully customer specific, other than in the number of times the reward may be received. While the system of the present invention supports customer specific targeted offers, they are by no means required. Offers can be made available to the general public, to loyalty cardholders, or to specific individuals with equal facility.

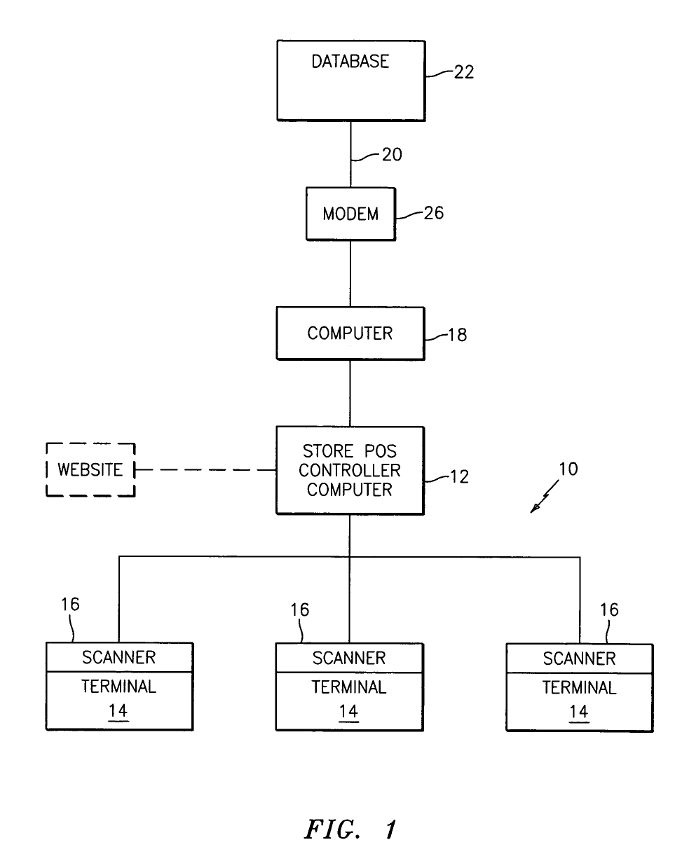

FIG. 1 is a schematic representation of the system of the present invention. As shown therein, the heart of the system is a central database 2 which contains a plurality of targeted electronic offers to be awarded to targeted individuals. The central database 2 may be stored on any suitable computer and/or server known in the art. The database 2 is accessible by entities such as product manufacturers, offer distributors, retailers, and other sources of targeted offers. Any suitable means known in the art, such as a modem 3, may be used to allow these entities access to the database 2. If desired, security means may be provided so that only authorized entities have access to the database 2.

The database 2 is compiled from electronic data files provided by the foregoing entities. Each data file includes information in electronic form about one or more offers to be made available to targeted individuals. The information for each targeted offer include the identity of a targeted consumer, information about a product to be discounted, offer conditions as discussed above, identification of one or more rewards, an identity of a specific location or retailer where the offer(s) are to be transmitted, an expiration date, and a limit on the number of uses of the offer.

As shown in FIG. 1, the database 2 is capable of communicating with a point of sale system 10 at a location such as a retail store location. While only one point of sale system 10 at a single location has been shown in the figure, it should be recognized that the database 2 may communicate with a plurality of point of sale systems 10 at a plurality of separate locations. As part of the system of the present invention, different targeted offers may be provided to different locations.

The point of sale system 10 communicates with the database 2 via a store central processing unit 18 and a store point of sale controller 12 which controls multiple point of sale (POS) registers or terminals 14 with scanners 16. As is well known, products purchased by a customer or consumer are passed over one of the scanners 16, which reads a bar code imprinted on the product. In a normal sales transaction, the terminal 14 and the processing unit 12 cooperate to identify the products being purchased, to effect a printing of a customer receipt, and to keep a complete record of the transaction. Communications between the database 2 and store processing unit 18 may be accomplished via any suitable means known in the art such as modem 26.

The controller 12 is provided with a local offer database and a redemption engine in software form. The local offer database and the redemption engine allow the controller 12 to have current information about electronic offers available to targeted consumers and to gather information about redeemed electronic offers. Periodically, such as daily, the gathered information about the redeemed electronic offers is transmitted via the controller 12, the processor 18, and the modem 26 to the database 2. The local offer database and the redemption engine also allow the point of sale system 10 to substantially instantaneously determine whether the conditions of a particular offer have been satisfied when a targeted consumer has been identified, such as by a frequent shopper number, and, if the conditions have been met, to substantially instantaneously validate the electronic offer and provide the designated reward(s) to the consumer. The consumer identification may be established in any suitable manner. For example, the consumer's frequent shopper number can be manually inputted using the terminal 14 and sent to the controller 12 electronically. Alternatively, the consumer identification may be inputted to the redemption engine by scanning a card containing the frequent shopper number and sent to the controller 12 electronically.

The redemption engine on the controller 12 may also be used to store information about each transaction involving a redeemed targeted offer. The information may be stored on the controller 12 and/or the processor 18. The stored information may include the customer identification information, the items purchased, the time of purchase, the electronic offers redeemed, and the reward(s) given to the consumer. As mentioned before, this stored information is periodically transmitted to the central database 2.

If desired, the controller 12 may be connected to a remote site for activating one or more of the offers stored on the local offer database. For example, a consumer may visit a website which lists available offers for him/her. By clicking on an icon representing a selected offer, the offer stored within the local offer database may be activated. Similarly, electronic offers stored in the local database may be made available to consumers by activating them using a kiosk at the location being visited by the consumer, a handheld PDA, or any other appropriate means.

If desired, each scanner 16 may also be used to scan paper coupons presented for redemption by a consumer. Information about the redeemed paper coupons may be forwarded to the local offer database and redemption engine and later forwarded to the central database.

As can be seen from the foregoing discussion, the system of the present invention makes available to each location 10 a multiplicity of targeted offers in electronic form. At each location 10, information is gathered about those electronic offers which have been redeemed by targeted individuals. This information is periodically transmitted to the central database 2 which is located at a remote offer processing center 22.

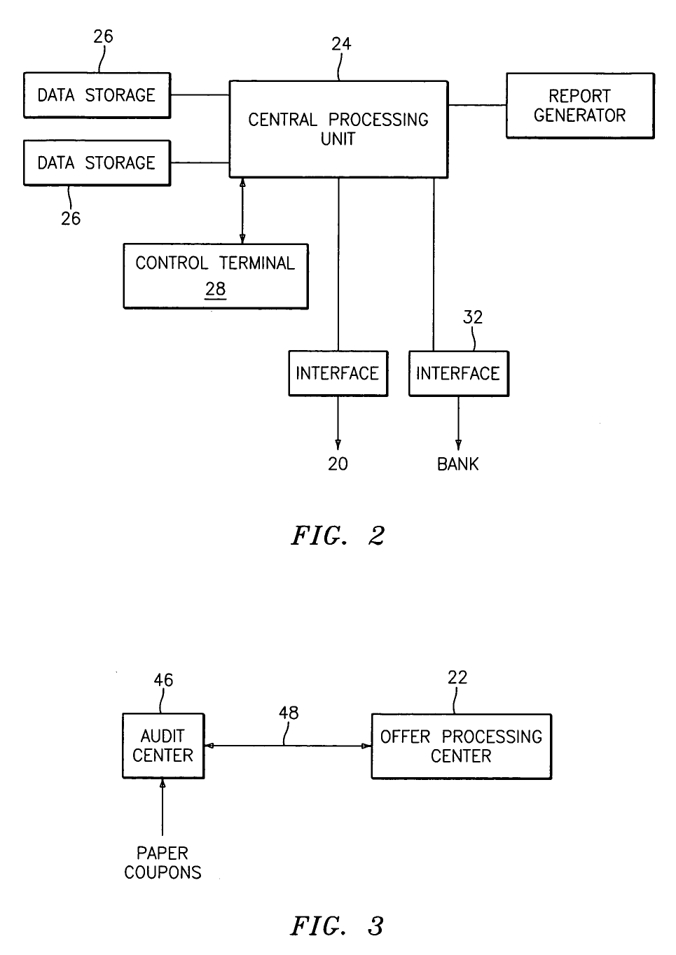

As shown in FIG. 2, the offer processing center 22 includes a central processing unit 24 which is preferably a fault tolerant central processing unit, using multiple redundancy of processing units and other components to minimize the possibility of on-line failure. The fault tolerant central processing unit 24 communicates with one or more storage devices 26, such as disk storage devices, on which the central database 2 is stored. If desired, the central database 2 may be stored in subparts on more than one storage device 26. In this way, one or more central targeted offer databases 26 may be created and maintained. The central processing unit 24 may also communicate with control terminals 28, a communications interface 30 for connection to the communication lines 20, and appropriate interfaces 32 for communicating with a bank 34 or other financial institution to perform electronic funds transfer (EFT).

The offer processing center 22 is used to recheck the validation of each redeemed offer to insure that the reward(s) have been properly issued. After the recheck has been completed, the processing center 22 determines electronically from the transmitted data an amount of money to be received by a seller or retailer at one or more of the store locations 10 from one or more of the entities providing the electronic offers. The center 22, after determining the amount of money owed the seller or retailer, transmits (1) a report of the monies to be received to the seller or retailer, and (2) a statement to each offer providing entity detailing the amount of monies to be paid to each seller. The reports and statements may be transmitted electronically or may be transmitted in paper form (via fax or mail) to the appropriate parties. If desired, the offer processing center 22 may maintain off-line archives of coupon data by periodically purging the offer databases.

Paper coupons redeemed in each of the locations 10 may be integrated into the system of the present invention. As mentioned before, the coupons may be scanned and electronic information about the redeemed coupons may be sent to the central offer processing center 22 and incorporated into the database 2. When paper coupons are incorporated into the System, as shown in FIG. 3, actual coupons may be sent to a coupon audit center 46, which may or may not be located near the offer processing center 22. Selected ones of the coupons may be audited in the coupon audit center 46. That is to say, selected physical coupons may be compared with electronic data pertaining to the corresponding sales transactions involving the selected coupons, transmitted over a communications link 48 between the offer processing center 22 and the coupon audit center 46.

An illustration of how the system and method of the present invention operates is as follows. On a visit to a retail store, the customer buys selected grocery- or other items and presents them for checkout, together with any paper coupons for which the customer is seeking redemption. During each sales transaction, the retailer scans the customer purchases and any paper coupons using the scanner 16 and the controller 12.

The next significant event in the sales transaction is the end of the transaction, as signaled by the sales clerk through the keypad on the terminal 14. At this point, the in-store controller 12 performs a preliminary coupon validation, using the local offer database on all electronic offers available to the particular customer and any paper coupons that were presented, and computes the reward(s) to be given the customer. As will be explained, a comprehensive validation process is performed at the coupon processing center 22, so in-store validation, while desirable, is not essential to the invention. The data obtained for each transaction about the redeemed offers and the rewards, redeemed coupons, customer identification, etc. are transmitted from the controller 12 to the computer 18 for storage and eventual transmittal to the central database 2. The computer 18, which is preferably operated strictly under the control of the independent offer processing agency managing the database 2 and the offer processing center 22, performs the following offer processing functions. Specifically, all redeemed offers and data about scanned coupons are logged and time-stamped to initiate an audit trail for the offer redemption transaction. Similar entries are created for offer “overrides,” manually entered offers, and invalid offers. “Overrides” arise when a sales clerk gives a discount to a customer in spite of an indicated error in the offer during validation. The clerk may override the error indication because of the busy condition of the checkout line, or to avoid or settle a confrontation with the customer, or for other reasons. The clerk is required to enter a code that indicates the reason for each override, and the override codes also become part of the record logged by the offer processing agency's in-store computer 18. In addition to the validation results, the computer 18 may record the value of each redeemed offer, the value of the items that the offers were redeemed for, and the value of all the items purchased in the transaction. Sales data may also be recorded for all of the items, or for selected items, purchased in the transaction.

At the end of each business day, the retailer in each store or location closes the POS system 10 and performs routine end-of-day processing. End-of-day offer redemption and redeemed coupon totals are transmitted to the processor 18. Then the processor 18 performs its own end-of-day processing, establishing a cutoff of data accepted from the store POS terminals 14, archiving the completed day's data, and initializing operations to begin a new day's processing. Next, the processor 18 in the store or location extracts data from the day's archives for transmission to the offer processing center 22. Preferably, this step includes encryption of the data before transmission to the offer processing center 22.

At the offer processing center 22, the transmitted data is authenticated and decrypted; then stored in the database 2. Also on a daily basis, but only after all the data has been-received from multiple store locations, the central offer processing computer 24 performs a validation check of all sales transactions in the daily data, using an accurate Family Code database. The Family Code for each product is a field of the Uniform Product Code for each redeemed offer and coupon, and is part of each record transmitted from the retail locations. The Family Code may be used to identify the product at least down to a level of product type, but may not necessarily be specific as to designations of size and other-factors. Family Codes are assigned by manufacturers to designate their products. A coupon, as well as an electronic offer, may be coded with a manufacturer's identification code, so the Family Codes may differ from one manufacturer to another. A key element of offer validation is the matching of the family code associated with the offer or coupon with a family code of a purchased item. This may be done initially in the retail store or location, but an inherent weakness of all in-store offer validation schemes is the existence of inaccuracies in the family code database used in the store for this matching process. One of the advantages of the system and method of the present invention is that an extremely accurate family code database may be maintained at the offer processing center 22. This allows the independent offer processing agency to perform a separate and independent offer validation on all offer and redeemed coupon records received from the retail store(s) or location(s). The results of the validation may be logged and exception reports are created as needed.

Once the family code check has been completed, the results may be analyzed for possibly questionable rates of invalid offer redemptions. Guidelines for acceptable rates of misredemptions may be set by the independent offer processing agency, or by individual retailers, and if the guidelines are exceeded, individual stores, or POS terminals within store, or individual sales clerks, may be targeted for auditing.

Other examples of the operation of the system and the method of the present invention are as follows.

### EXAMPLE 1

The marketing department of the XYZ Corp has decided to allocate a portion of its budget for promotional offers away from ABC's to target offers to individual consumers/households. It will utilize differentiated discount levels and offer conditions (e.g. discounts ranging from 15% off to 40% off; quantity discounts; tie-ins to other XYZ products; tie-ins to other items or product families) for each of ten XYZ products, and will use them to create various offer packages for different consumers, utilizing targeting metrics derived from market analysis and/or the input of a targeting consultant. The targeted consumer is identified by his or her frequent shopper identification number with a particular retailer. XYZ has arrangements with a number of retailers for purposes of targeting the offers. The consumers will be informed of the offers through one or a variety of means: direct mail, Internet, in-store media, etc.

In order for the clearing and settlement functions of the present invention to be performed with respect to the multiplicity of offers, XYZ must submit an electronic data file, at or near the time, the offers are created and/or distributed, containing the pertinent offer information, the targeted consumer, the product to be discounted, the offer conditions, the amount of the discount or other reward, the applicable retailer and/or retail locations associated with the offer and/or consumer, the expiration date, limits on number of uses, etc. to the central database 2.

Thus, if XYZ has issued an offer to QRS' customer, Mrs. Jones, to receive 255 on Cheerios within a certain timeframe and conditioned on the purchase of certain other items, and submitted the appropriate offer file to the database 2 in accordance with the prescribed offer definition format, when Mrs. Jones' card is scanned at the QRS checkout aisle, and the sales transaction reflects the purchase of Cheerios in conjunction with the other requisite offer conditions (if any), the redemption engine (which resides on the store controller 12 and is configured to communicate with the register terminal 14 sales program) will inject the appropriate discount into the transaction.

The validation that occurs in real-time through the redemption engine will be rechecked by the central processing center 22 upon retrieval of the TLOG (with the record of the redemption and of the sales transaction total which it relates) to ensure that the offer is one that was in fact submitted by XYZ, and, that the discount was given, at the appropriate level, for a sale that actually occurred, to an individual in possession of the target consumer's identification card. Once this revalidation is complete, the reimbursement value to which QRS is entitled will be included on the next invoice electronically generated and transmitted by the system of the present invention to XYZ on behalf of QRS, and the payment thereafter processed in a matter of days, with the drawn-out counting and/or verification process otherwise necessary.

The system of the present invention is not a mechanism for creating or distributing the targeted offers, but it enables those processes to exist because it provides the back-end means for processing the offers at the point of sale and through the settlement and reporting process, and provides independent verification and controls without which mass scale target promotions would be impossible.

### EXAMPLE 2

OD1, a company in the business of distributing coupons to individuals over the Internet, wants to avoid the security and fraud problems inherent in print-at home programs. It therefore enters into arrangements with a number of retailers to access their customer bases for purposes of tying OD1's electronic offers, funded by OD1's CPG manufacturing clients, to the retailers' respective customers who are also members of the OD1 network. The electronic offers will be redeemed and settled via the system of the present invention, and OD1 will submit offer files to the central processing center 22 with the appropriate details in conforms with the offer definition formats, so that the OD1 member/recipient of the electronic offer will be able to receive the promised discount or other reward at the qualified retailer checkout line, as described in Example 1 above. Depending on the needs of OD1 and/or its CPG clients, the offer may not be activated in the system until the consumer clicks on the offer on the OD1 website or otherwise confirms awareness of the offer.

### EXAMPLE 3

Carafina distributes a list of electronic offer discounts, similar to the paper coupons distributed by Carafina, and using the same in-lane printers, to shoppers as they checkout, the offer information is simultaneously fed to the central database 2, attached to the shopper ID of the consumer receiving the offer. The system of the present invention provides a means of thereafter redeeming, clearing, and settling the offer without the necessity of paper processing. In the case of Carafina and the retailers and manufacturers with which it does business to avoid the expense, delay and potential for malredemption and misredemption associated with paper coupons, and the ability to tie the offer to the particular consumer whose purchase behavior triggered the issuance of the offer in the first place.

### EXAMPLE 4

Utilizing trade funds or internally generated marketing budgets, S&S wishes to manage its markdowns by targeting some offers to only selected customers, based on loyalty or targeting criteria it develops with assistance of a targeting consultant. In this instance, S&S itself, or its ad-planning agency, will submit the offer files to the system of the present invention, at or around the time, the offer is distributed (via mailings, the S&S website, in-store devices, etc.) to the consumer. Among other things, this method of promotional offers provides “stealth” marketing that is insulated from being undercut by competitors in the manner that S&S's highly visible weekly insert can be.

As can be seen from the foregoing examples, the system of the present invention is a back-end infrastructure for processing electronic offers and targeted electronic offers.

With respect to the auditing of redeemed paper coupons, each retail store may gather scanned and non-scanned coupons into two daily bags of coupons and may transport them periodically to the retailer's headquarters, where the coupons are accumulated, logged, weighed, packed in boxes and transported to the coupon audit center 46. At the audit center 46, arriving bags may be weighed again (for an approximate coupon count) and assigned a tracking number to assist in subsequent tracing of the coupons if needed. Next the coupons may be sorted into bins, with one bin per store per week. The coupons may be logged in as they are placed into the bins, and bin labels may be printed. Later, bins with labels marked for audit may be sent to an audit station. Selection of bins for audit can be based on stores and dates selected as a result of the validation check done on the electronic coupon records in the offer processing center 22, or may be a random selection. On occasion, such as during start-up testing, it may be necessary to perform a full (100%) audit in which all coupons are compared with the electronic coupon records.

Coupons selected for audit entered into an audit center computer (not shown) and a preliminary comparison is made between the physical coupons and corresponding electronic coupon data obtained from the database 2 maintained at the coupon processing center 22. Each physical coupon can be identified>as to the date it was redeemed; the store it was redeemed in, and even the POS terminal that scanned it, so corresponding coupon and sales transactions data can be located in the coupon database 2. Non-scanned coupons are also entered into the audit center computer. Any changes in the electronic coupon data, based on the results of the preliminary audit, are transmitted to the coupon processing center 22. The coupon data changes for both scanned and non-scanned coupons are merged with the database 2. After entry and audit, all coupon bins may be sent to storage racks.

Manufacturers and retailers may elect which stores and dates are to be audited. This information may be entered into the audit system. In addition, the audit system may perform a random selection of stores and dates to audit. The auditing system then creates reports of stores and dates to audit and prints labels to identify bins for audit. The marked bins may be retrieved from their storage racks and sent to an audit station, and then a full audit analysis may be performed, comparing the physical coupons with the electronic coupon records. Adjustments may need to be made to manufacturers' and retailers' statements as a result of the full audit analysis. Also as a result of the analysis, stores with coupon processing problems may be identified.

Billing of manufacturers from the offer processing center 22 may occur on a weekly cycle. The functions performed by the offer processing computer 24 during this phase of offer processing include selecting a period to process, merging offer changes made as a result of audits against physical coupons, and then, creating a summary bill by manufacturer, chain, store, and day. The offer processing center computer 24 may analyze the summary billing data as compared with historical trends and creates control reports. It may also be used to analyze the control reports, research the database(s) 2, and make any needed adjustments before running the final bills. The bills may be sent to each manufacturer by electronic data interchange (EDI) or as paper invoices. Finally, the system of the present invention creates detailed reports pertaining to the redeemed offers and coupons for each manufacturer. These reports may be derived in part from the suffix codes on the coupons or offers scanned in the retail stores. The suffix code data may be formatted in a manner not yet standardized, so analysis of this data must usually be left to the manufacturer. Alternatively, the manufacturer may provide the coupon processing agency with coding information pertaining to the suffix codes, allowing the analysis of suffix code data at the processing center 22. The billing, offer details, and retailer results may be transmitted to a manufacturer clearing agent, to be merged with the traditional offer clearing process.

The offer processing center 22 may perform weekly and monthly analyses on the accumulated offer data. In a weekly analysis, the center may process offer records against statistical norms, analyzes historical trends, and summarizes Family Code validation errors. Exceptions in the data may be analyzed and then, reports and detailed analysis data may be transmitted to manufacturers and archived in the central database(s) 2.

Substantially the same functions may be performed on a monthly basis, with detailed analysis reports going to manufacturers and retailers.

Suffix codes contain information such as coupon expiration date, the offer code, and the household ID. Suffix codes cannot presently be read by most in-store scanners. In one embodiment of the present invention, the suffix codes are made available for reading at the POS terminals 14 in the retail stores. This is accomplished by one of two approaches. In one approach, the presently used POS scanners 16 are upgraded to read the suffix codes as well as the primary codes, and to provide the suffix code data to the processing unit 18. Alternatively, a new generation of scanners will be able to read the suffix codes along with the primary codes. The processing unit 18 can then obtain all of the coupon data, including suffix codes, from the “store loop”, the communications path linking the POS terminals 14 and the store central processing unit 12.

By way of example, suffix codes may be read by scanning apparatus such as that described in U.S. Pat. No. 5,128,520 to Rando et al and U.S. Pat. No. 4,879,456 to Cherry et al., both of which are incorporated by reference herein.

Offer code data may be initially transmitted to the offer processing center 22 from the manufacturer to provide a baseline database 2 of registered offer codes at the center. On a periodic basis, such as weekly, the manufacturer may define new offers and transmit updates to the offer processing center 22. Also on a periodic basis, the offer processing center 22 may process accumulated suffix code data against the offer code database for each manufacturer.

At this stage of processing the suffix codes, the offer processing center 22 may detect invalid offers and coupons, based on invalid offer code transactions. These may be accumulated for billing adjustments.

The offer code can be used by the manufacturer not only to define any special terms of the offer, but also to indicate where the offer originated, whether distributed by direct mail, in a store or in product packaging. This information is obviously of enormous benefit to the manufacturer, especially if it can be made available on a timely basis. If a manufacturer does not make its offer code data available to the processing center 22, then the center 22 cannot process the suffix code data, except to the extent that various fields are recognized. In this case, the suffix code data may be shipped to the manufacturer, either in detail or by way of summaries by product or family code. Whether the suffix code processing is performed at the processing center 22 or by the manufacturer itself, the manufacturer obtains timely information about how various offers are received in various locations and using various offer distribution techniques. Use of the information allows the manufacturer to make meaningful and timely adjustments to an ongoing promotion, or to discontinue it altogether.

Another important use for the offer code is to allow manufacturers to perform cost accounting down to a product level. Manufacturers would like to be able to determine accurately how much of a total promotion cost to allocate to various products covered by the promotion. That determination is based in part on the redemption counts for the various products. In the past, offer redemptions could only be accounted, with any accuracy, down to the family code level. The number of family codes available to a manufacturer is limited and the same specific family code may include multiple brand names, sizes or types of product made by the same manufacturer. Access to the family codes associated with the offers provides the manufacturer with more accurate data for the desired cost accounting.

A manufacturer may optionally use suffix code data to trigger the printing of one or more additional coupons in the retail store. The printing of such a coupon may be triggered by the detection of a preselected code on a discount coupon rather than a preselected product code on a purchased item. The suffix code for triggering may be the offer code or any other field on the coupon, such as the household ID, to permit printing a coupon for a target household. The mechanism may also be used to tie or cascade one coupon promotion to another.

The manufacturer or distributor of the promotional offers or coupons which have been registered in the central database 2 may select which retail stores or locations are to be provided with information about the details of one or more of the registered offers or coupons. This information may be electronically delivered, such as by the Internet, telephone lines, and/or the transmittal of disks or CD-Roms containing the information, by the center 22 to the computer(s) 18 at the location(s). The information may then be stored in the local offer database and supplied to the computer 12 and the terminals 14.

It can be appreciated from the foregoing that the present invention provides a significant improvement in the way offers and discount coupons are processed during and after redemption in a retail store. In particular, the invention provides a more efficient way to validate and clear offers and coupons, generating automatic bills to the manufacturers and payments to the retailers, but with only a single count being taken of the redeemed offers and coupons. In addition to providing an efficient clearing and payment process, the invention provides a much reduced level of offer and coupon misredemptions by continually updating a family file database for periodic distribution to retailers. Finally, the invention in one of its embodiments provides suffix code data to manufacturers, to further enhance the proportion of valid redemptions and to enable manufacturers to modify or terminate offer and coupon promotions based on timely reports of the effectiveness of the promotions.

The system and method of the present invention allows improvements in the efficiency of offers and allows an increase in the accuracy of future targeting. They also allow a way to link the correct consumers in real-time, during the checkout process with the most appropriate offer, incentive, coupon, or promotion.

One of the principal advantages to the system and method of the present invention is the maintenance of a central offer database or databases 2 that is open for all participant's offers, e.g. registered manufacturer's or distributor's offers, to be managed which is unlike dedicated, vertical or proprietary closed systems.

The system and method of the present invention provide an infrastructure that is capable of connecting targeting-capable media, such as web browsers, e-mail, in-store kiosks, PDA's, mobile phones, interactive TV, direct mail, and others, to the POS systems of retailers for electronic redemption of rewards in real time, while the consumer is checking out. An open system permits the offers from all interested marketers or offer distributors to be accepted and retailers are enabled to implement a single universal solution. This makes available the broadest possible array of offers to a retailer's customers.

Each participant in the system of the present invention benefits as they are able to accept offers from emerging and new media sources without delay in their stores. New media technologies and implementers are now able to offer reliable empirical census data supporting the efficiency of their method of distribution and targeting.

The system and method of the present invention resolves the problem plaguing Internet-based print-at-home coupons. Print-at-home coupons have not been embraced by manufacturers because of the security issues such as copying and face value alteration. These security issues have created a great barrier to their acceptance. Using the system and method of the present invention Internet-based targeted offers overcome security issues. The security issues are resolved by eliminating the need for paper coupons and ensuring that offer conditions are enforced, in addition to validating that the requisite purchases are made.

The system and method of the present invention enable offers from many distributors to be made available to every retailer that is offering the product(s) with incentive offers from the many distributors, thus creating a type of meta incentive offer system. The promotional offer is transformed from paper or other form and becomes transcendent from the original medium and is actionable by a consumer that encounters the system of the present invention. The present invention solves the problems of those distributors who are not willing or able to develop the separate infrastructure for each retailer, channel or class of trade that would be required to accomplish creation, distribution, and clearing of offers.

The system and method of the present invention permits anyone acting as a distributor of an offer to access the system and incorporate their offering into the open system for redemption at desirable retailers and to specified customers. The distributor may gain access to the system of the present invention via the-Internet and in particular to a central offer database 2 which forms part of the system of the present invention.

Using the system and method of the present-invention, each participant is now able to begin connecting targeting-capable media such as direct mail, in-store kiosks, e-mail, web browsers, PDA's mobile phones, interactive TV, and others, to the POS systems of retailers for electronic presentment and redemption of rewards in real-time, while the consumer is checking out. The retail participants, as a result, deliver more incentive offers and the most valuable incentive offers that are targeted for the customer that is identified. Likewise, distributors are able to locate and deliver the most up to date and best value offers able to be presented to a customer interacting with their media technology.

The improved system and method of the present invention tracks the offer incentives and is able to provide information reports to manufacturers and retailers. Today, each participant has insufficient information with which to create or modify the promotions at any point after an incentive offer is initiated by a distributor. Implementing the system and method of the present invention permits the immediate monitoring of performance and modification of any electronically created offer at any point prior to being redeemed and the targeting is able to be improved to satisfy the marketing goals of the participant distributor.

The system and method of the present invention permit efficient measurement of consumer activity for identified coupons or offers because of the distributors having been registered by them and traceable from being issued to redemption. The system and method of the present invention has the ability of tracking offers from many distributors to many retailers and to have measurements of performance through actual product movement as a result of the promotion.

Using the system and method of the present invention, distributors are able to influence brand loyalty based upon offer performance. With this system, one distributor is able to send offers to many retailer system participants and then measure the performance of the incentive offer by individual at any participating retail location. With each customer identifying themselves with a registered distributor's offer or frequent shopper or loyalty card, past purchase behavior is now able to be measured and thus the return on investment of an incentive. Present day systems are unable to do this efficiently.

The system and the method of the present invention can determine that a coupon presented by a customer at the point of sale is invalid. This virtually eliminates coupon malredemption.

With the system and method of the present invention, paper coupons are converted to electronic offers and the validation and audit trail are linked.

It should be appreciated from the foregoing that the present invention represents a significant advance in the field of offer processing in the retail sales field. In particular, the invention provides a new way of processing discount offers that requires only a single physical coupon count, but automatically and reliably effects payments of retailers for the collection and handling of manufacturers' offers. Potential disagreement over multiple physical counts is avoided because the system of the invention provides a reliable audit trail to provide auditing against any selected percentage of the offers. In addition, the system of the present invention provides timely reports of offer usage to the originating manufacturers, including reports of misredemption rates and reports of coupon effectiveness.

It is apparent that there has been provided in accordance with the present invention a system and method for managing incentive offers which fully satisfies the objects, means, and advantages set forth hereinbefore. While the present invention has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

1. A method for handling the redemption, clearing and settlement of a large number of individually targeted offers comprising the steps of:
compiling a database of electronic offers;
allowing access to said database by at least one point of sale system;
providing said at least one point of sale system with a redemption engine for validating at least one offer to be made to a consumer while a sales transaction is being processed by the at least one point of sale system;
identifying a consumer and a sales transaction event involving said consumer;
using said redemption engine to determine whether electronically stored conditions of any offer available to said consumer and stored on said database have been satisfied; and
providing a reward to said consumer at said at least one point of sale system if said redemption engine determines that said electronically stored conditions of any offer have been satisfied.

2. A method according to claim 1, wherein said compiling step comprises receiving an electronic data file containing information about at least one offer from an entity.

3. A method according to claim 2, wherein said receiving step comprises receiving an electronic data file from a product manufacturer.

4. A method according to claim 2, wherein said receiving step comprises receiving an electronic data file from a retailer.

5. A method according to claim 2, wherein said receiving step comprises receiving an electronic data file from a distributor of offers.

6. A method according to claim 2, wherein said electronic data file receiving step comprises receiving in electronic form information about at least one offer available to a number of targeted individuals.

7. A method according to claim 6, wherein said receiving step comprises receiving for each said offer at least one of information about a targeted consumer, information about a product to be discounted, offer conditions, identification of a reward, an identity of a retailer, at least one retail location to which said offer may be transmitted, an expiration date, and a limit on number of uses of the offer.

8. A method according to claim 1, wherein said identifying step comprises identifying said consumer via a specific consumer identifier.

9. A method according to claim 8, wherein said identifying step comprises identifying said consumer via a frequent shopper number.

10. A method according to claim 1, wherein said redemption engine providing step comprises providing said redemption engine on a controller associated with said at least one retail point of sale system.

11. A method according to claim 1, further comprising rechecking validation of a redeemed offer at a central system remote from said at least one retail point of sale system.

12. A method according to claim 11, wherein said rechecking step comprises performing said rechecking step at a non-retail store location.

13. A method according to claim 11, wherein said rechecking step comprises:
retrieving a log from said at least one point of sale system which contains a record of each redeemed offer and each sale transaction involving each said redeemed offer and identification of each consumer redeeming each said redeemed offer;
transmitting said log to a processor at said central system; and
verifying that said electronically stored conditions for each said redeemed offer were met and that each said reward was appropriately issued using said processor at said central system.

14. A method according to claim 11, further comprising providing a reimbursement value for each redeemed offer to a creator of each said redeemed offer after said rechecking step has shown that each said redeemed offer has been properly redeemed.

15. A method according to claim 1, further comprising activating at least one offer stored on said electronic database by having said consumer first click on said at least one offer on a website.

16. A method for processing targeted incentive offers comprising the steps of:
electronically entering information about at least one targeted offer into a central database;
placing the database into communication with a point-of-sale system at another location;
transferring data about each redeemed offer from the point-of-sale system for validation;
validating each said redeemed offer;
electronically determining from the data an amount of money to be received by a seller from at least one offer source;
providing a report of monies to be received to the seller; and
providing a statement of monies to be paid to the seller to each offer source.

17. A method according to claim 16, wherein said entering step further comprises entering into said database at least one of a product and a product category for which each said offer may be used, and entering data defining a value for each said offer into said database.

18. A method according to claim 16, further comprising:
maintaining a local offer database at said another location; and
said communication placing step comprising providing information about at least one available targeted offer to said local offer database.

19. A method according to claim 18, wherein said data transferring step comprises periodically transferring redeemed offer data from said local offer database to said central database.

20. A method according to claim 18, further comprising:
converting information on paper coupons submitted for redemption to an electronic file;
transferring said electronic file representative of said converted information to said local offer database;
periodically transmitting said electronic file to said central database; and
determining from said transmitted electronic file and said information in said central database whether said converted paper coupons have been properly redeemed.

21. A method according to claim 16, wherein said entering step comprises entering targeted offers from multiple offer sources.

22. A method according to claim 16, wherein said validating step comprises comparing data about each transaction involving each said redeemed offer with redemption conditions stored in said central database to insure that said redemption conditions have been met.

23. A method according to claim 16, further comprising auditing at least some transactions relating to redeemed offers.

24. A method according to claim 16, further comprising:
logging and time stamping offers being redeemed; and
transmitting information about said logged and time stamped offers to said central database.

25. A method according to claim 16, further comprising:
logging overrides performed by personnel at each POS terminal in said point of sale system; and
transmitting information about said logged overrides to said central database.

26. A method according to claim 16, further comprising analyzing said transmitted redeemed offer data for questionable rates of invalid coupon redemptions.

27. A system for handling the redemption, clearing and settlement of a large number of individually targeted offers comprises:
a database of electronic offers;
means for allowing access to the database by at least one point of sale system;
said at least one point of sale system being provided with a redemption engine for validating at least one offer to be made to a consumer while a sales transaction is being processed by the at least one point of sale system;
means for identifying a consumer and a sales transaction event involving said consumer;
said redemption engine determining whether electronically stored conditions of any offer available to the consumer and stored on the database have been satisfied; and
means for providing a reward to the consumer at the at least one point of sale system if the redemption engine determines that said electronically stored conditions of the offer have been satisfied.

28. A system according to claim 27, further comprising means for inputting an electronic data file contain information about at least one targeted offer from at least one entity.

29. A system according to claim 27, wherein said consumer identifying means comprises means for identifying said consumer via a specific consumer identifier.

30. A system according to claim 27, wherein said consumer identifying means comprises means for identifying said consumer via a frequent shopper number.

31. A system according to claim 27, wherein said redemption engine is resident on a controller associated with the at least one point of sale system.

32. A system according to claim 27, further comprising means for rechecking validation of a redeemed offer at a central system remote from the at least one point of sale system.

33. A system according to claim 32, wherein said rechecking means comprises means for retrieving a log from the at least one point of sale system which contains a record of each redeemed offer and each sale transaction involving each said redeemed offer and identification information about each consumer redeemed each said redeemed offer, and means for verifying that electronically stored conditions for each said redeemed offer have been met and that each said reward was appropriately issued.

34. A system according to claim 27, further comprising means for activating at least one offer stored on the database by having said consumer first click on the at least one offer on a website.

35. A system for handling the redemption, clearing, and settlement of a large number of individually targeted offers comprises:
a central database having information about at least one targeted offer;
means for placing the database in communication with a point-of-sale system at another location;
means for transferring data about each redeemed targeted offer from the point-of-sale system for validation;
means for validating each redeemed targeted offer;
means for electronically determining from the data an amount of money to be received by a seller from at least one offer source;
means for providing a report of monies to be received to the seller; and
means for providing a statement of monies to be paid to the seller to each offer source.

36. A system according to claim 35, further comprising:
said point-of-sale system having at least one point of sale terminal;
each said point-of-sale terminal having a scanner for scanning redeemed paper coupons; and
a local offer database connected to each said terminal for receiving and storing information from each said terminal about said scanned coupons.

37. A system according to claim 35, further comprising means for auditing at least some transactions relating to redeemed offers.
